(19) United States
(12) Patent Application Publication
(10) Pub. No.: US 2004/0074019 A1
(43) Pub. Date: Apr. 22, 2004

(54) Method of manufacturing and distributing a garment memorializing a place or object

(76) Inventors: Jack T. Kahl, Baltimore, MD (US); Steven K. Brown, New Albany, IN (US)

Correspondence Address: FITZPATRICK CELLA HARPER & SCINTO, 30 ROCKEFELLER PLAZA, NEW YORK, NY, 10112, US

(21) Appl. No.: 10/381,028

(22) PCT Filed: Sep. 21, 2001
(86) PCT No.: PCT/US01/29584

(51) Int. Cl. C09B 1/00

(52) U.S. Cl. 8/636

(57) ABSTRACT

A method of manufacturing and distributing a garment that commemorates a memorable place or tangible object. The method comprises the following steps: (a) converting at least a portion of the place or object to a particulate form, (b) mixing the particulate matter with a dye composition to form a dye mixture, (c) obtaining a quantity of dyeable garments, (d) dyeing at least a portion of each of said garments, using said dye mixture, and (e) distributing the dyed garments to members of the public, each one accompanied by a visually readable imprint that informs the reader that the garment has been colored in a formulation that contained at least a portion of the object and that identifies the nature of the portion that was used. A winning race car, for example, may be commemorated in this manner by mixing paint scraped from the car with a dye solutioln of approximately the same color and using the resultant slurry to dye t-shirts that are then tagged as to origin and distributed in commerce.

This invention concerns a method of manufacturing and distributing a garment—in particular, a garment that commemorates a place or tangible object. The place may be any memorable site—e.g., the location of an historic event, a memorial park or cemetery, or a place of public accommodation. The ground where a famous battle was fought, a building that has served as a gathering place for people, and a playing surface on which spectator events have been presented are all examples of such places. The tangible object may be any memorable item of personal property—e.g., something that has served as an instrument in the performance of a spectator event. A race car that has been declared the winner of an officially sanctioned automobile race is an example of such an object.

Places of public accommodation such as athletic stadiums, race tracks, and the like sometimes become so well known, e.g., through years of use by a particular team or for a particular event, that members of the public want to possess mementos of the place. Thus, for example, when the stadium in which a professional baseball team has played for decades is to be vacated, or tom down and replaced, fans of that team, who treasure the memory of games they have seen played there, might wish to have souvenirs such as seats and the like from the stadium.

Tangible objects that have served as instruments in the performance of spectator events sometimes become so popular among fans of the object or the person using it that the fans desire to possess, if not the object itself, some portion of it. Thus, for example, fans of stock car racing might wish to have some portion of the winning car of a major race as a souvenir or memento of the car, the driver, or the race. Upholstery or trim from the car can be removed, divided into pieces, and distributed to fans for that purpose. Also, the tires that the car rode on in winning the race can be cut into pieces and those pieces distributed to eager fans. Years ago, when the famed Orient Express train was discontinued, objects from the dining cars, such as table lamps, were distributed to fans and former passengers on the train.

Such mementoes of memorable places or objects serve to entertain, perhaps decorate homes, and/or generally enrich, sometimes in a light-hearted way, the lives of the fans who possess them. There are, however, a relatively limited number of such relics that can be obtained from any such place or object. Thus, for example, there are a relatively limited number of seats in any stadium that can be distributed to the public, a limited amount of sod from an historic battlefield or favored playing field that can be carried home by fans to implant in their lawns or gardens, and a limited number of pieces of any famous race car that can be distributed to the driver's fans.

Generally speaking, the present invention resides in the use of a dye mixture comprising dye and particulate matter for dyeing the garment.

Specifically, the present invention provides a method of manufacturing and distributing a garment that truly commemorates such a place or object, but does it in such a way that the place or object involved (the building, the field, the race car, or the famous rail car) generates more mementoes than is possible by dividing up the real estate or object and distributing its pieces. The manufacturing and distributing process of the present invention comprises the following steps:

a) converting at least a portion of the place or object to a particulate form,

b) mixing said particulate matter with a dye composition to form a dye mixture,

c) obtaining a quantity of dyeable garments,

d) dyeing at least a portion of each of said garments, using said dye mixture, and

e) distributing said dyed garments to members of the public, accompanied by a visually readable imprint that informs the reader that the garment has been colored with a formulation that contained at least a portion of said place or object and that identifies the nature of the portion that was used.

As mentioned, a prime example of a memorable object that can be used is any object that has served as an instrument in the performance of a spectator event. As suitable spectator events might be mentioned, for example, sporting events, music concerts, speeches, conventions, contests of all types, and feats of derring-do. Instruments used in such events might include, for example, in addition to race cars, motorcycles, boats, bats, racquets, hockey sticks and pucks, running shoes, athletic headgear, guitars, pianos, costumes, and stage props.

As for memorable places, any portion thereof will suffice. What is most important is that it be authentic and be capable of being converted into particulate form. Thus, for example, if the place includes a grass field, e.g., a battlefield or a playing field, some of the grass clippings can be removed. Alternatively, whole pieces of sod can be removed. If it is a dirt playing surface, a part of the dirt can be removed. If it is a wooden playing surface, such as a basketball court, part of the wooden floor can be removed. If it is a playing field covered with artificial turf, part of the artificial turf can be removed. If it is an automobile race track, part of the track surface can be removed; for example, tire rubber that has adhered to the track surface can be scraped off. (For purposes of the present invention, such tire rubber would be considered part of the playing surface.) Alternatively, if it is an asphalt racing surface, part of the asphalt can be removed. If it is a brick racing surface, part of the brick can be removed. If it is a dirt track, part of the dirt can be removed.

If the place to be commemorated includes a building that has served as a gathering place for people, e.g., a stadium or arena, any portion of the building structure can be removed, e.g., bricks from the exterior facade or paint from a wall.

As for memorable objects, the entire object, or any removed portion thereof, may be used in the present process. Again, what is most important is that the object or removed portion be authentic and be capable of being converted into particulate form. Thus, for example, if the object is painted, some or all of the paint can be scraped off. Alternatively, whole pieces of the object can be removed, or, of course, the entire object can be used.

The removed portion of the place or object (or the entire object, if that is what is being used) can be converted to a particulate form using equipment and methods well known in the art of comminuting materials. Grinders, pug mills, shredders and the like can be used, depending on the nature of the particular material involved. If immersion dyeing is used (which will be discussed later herein) the material preferably is converted into small enough particles that, when agitated with the garments in the dye solution, they will not tear or visibly abrade the garments. This is particularly preferred in the case where the removed material is masonry, wood, metal, ceramic, or a heavy, rigid plastic.

If the dye composition is to be used to make an imprint on the garment by screen printing (also to be discussed hereinafter), preferably the particle size will be small enough that at least some of the souvenir material can pass through the openings in the screen, carried by the textile ink.

Where the removed portion is cured paint, if it is separated from the object by scraping, then that one act of scraping (with collection of the paint particles) can possibly serve to both remove and convert the material to particulate form.

Where the removed portion is grass, if it is separated from the playing field by mowing, then that one act of mowing (with collection of the clippings) can serve to both remove and convert the material to particulate form. Preferably, however, the grass clippings are cut into even smaller particles, e.g., by use of a mulching machine, before they are mixed with the dye solution.

Similarly, when the removed portion is dirt, the steps of removing and converting into particulate form can again be merged into one act—i.e., shoveling the dirt from the field and dumping each shovel-full into a transportation container can serve both to remove the dirt and convert it into particulate form. If desired, the dirt can also be raked, to assist with the conversion.

By “dye composition” is here meant any dye or ink composition that can be used to either color an entire garment or print a design on it. By “color” we mean to include black and white, as well as the hues that ordinarily are considered “colors”.

If the entire garment is to be colored, the choice of dye composition to use is made based upon the nature of the fiber content of the garment, as is well known in the art. Thus, for example, cotton can be dyed with direct, developed, sulfur, napthol, and vat dyes; wool can be dyed with acid, basic, chrome and direct dyes; and many synthetic fibers can be dyed with napthol, azoic, and acid dyes.

If the dye composition is to be used to make an imprint on the garment, e.g., by stencil printing, it will preferably be a textile ink. Textile inks contain pigment, solvent, and a binder (sometimes called “varnish”). Usually the binder is a heat-setting one that will cure at some temperature in the range of about 275 to 375° F.

Preferably, the color of dye composition chosen will be at least approximately the same as that of the portion of the place or object that is used—e.g., green dye where grass is being used, black dye where asphalt and/or tire rubber is being used, etc. Most preferably the color of the dye composition will be within about five or ten shades from the original on the Pantone color chart.

Aqueous dyeing solutions are preferably used for all-over dyeing, e.g., a solution of either a reactive dye or a pigment dye. The dye can be added to the water either before or after the particulate matter from the object. Preferably enough of the particulate material is used that all of the garments will be impregnated by it to some extent when they are colored by immersion dyeing. This requires that at least a fraction of the particulate material be small enough in size that the particles can become lodged in the fibers of the fabric.

As indicated above, the dye mixture that contains the souvenir particulate material can be used either to color the entire fabric or to color just a portion of the fabric. For example, the dye mixture can be an ink composition that is used to imprint an image on the garment, for example by screen printing.

For all-over dyeing, the dye mixture will be a slurry of the particulate material in a dye solution, and it preferably will be used to dye a quantity of the garments all at once. Thus, for example, a quantity of undyed, dyeable garments are immersed in the dye slurry, the garments are then agitated so as to color them, then they are removed from the dye slurry and rinsed with water, following which they are dried.

When formulating the dye slurry, preferably about 1 to 4 pounds (especially 1.5 to 2.5 pounds) of the particulate matter for each 240 gallons of the dye solution is used. Expressed otherwise, preferably at least about 0.05 percent, e.g., about 0.05 to 0.2 percent, of the particulate material is used, based on the weight of the dye solution. In another embodiment about 3 to 5 percent of the particulate material is used.

When using an ink-type dye composition to screen print a design on the garments, it, too, will preferably contain at least about 0.05 percent of the souvenir particulate matter, e.g., in the range of about 0.05 to 10 percent, based on the weight of the textile ink.

When immersion dyeing is employed, conventional piece dyeing equipment can be used, e.g., using a kettle dyeing process or a vat dyeing process.

As for the nature of the garments, they can be anything that can be fabricated out of dyeable fabric, e.g., t-shirts, sports jerseys or pants, jeans, jackets, hats, socks, ties, or pyjamas. By “dyeable” is here meant capable of accepting a permanent color, either by dyeing or by stencil printing. Shirts and pants are preferred, especially t-shirts, baseball-style shirts, and football-style jerseys.

As regards the fiber content, it can be any dyeable textile fiber. Such fibers include natural materials like cotton, wool, and silk, as well as synthetic materials like polyester, rayon, and nylon.

The garments are preferably made at least in part of cotton, e.g., either 100% cotton or a blend of cotton and polyester fibers.

The fabric of which the garments is made may be knitted or woven.

When immersion dyeing is used, the rinsing and drying of the dyed garments can be performed using equipment and methods that are well known in the art. When screen printing with a textile ink containing the souvenir particulate matter, heat conveyors, e.g., of the type conventionally used in t-shirt screen printing operations can be used.

It has surprisingly been found that the presence of the particulate matter in the dye slurry can cause the finished garment to be more susceptible to fading. To combat this, it is preferred to use a dye that has a lightfastness classification of at least L4 on the xenon arc 20 hour Colorfastness to Light Test Method 16-1998, as described at pages 24-35 of AATCC Technical Manual 1999, which is published by the American Association of Textile Chemists and Colorists. A lightfastness classification in the region of L4 to L5 generally is most preferred.

Most preferably, the dye will also have a classification of at least Grade 4, as regards the predominant fiber in the fabric, as measured by AATCC Colorfastness to Perspiration Test Method 15-1997, using the Gray Scale for Staining Scale, which method is described at pages 21-23 of AATCC Technical Manual/1999. If the fabric is composed of a mixture of two or more different types of fibers (e.g. cotton and polyester), it is most preferred that the dye used be at least a Grade 4 with respect to each of the different fiber types. Most preferably, the colorfastness will be in the region of Grade 4 to Grade 5.

As far as the chemical composition of the dye is concerned, dyes whose molecules have one or more reactive groups selected from vinyl sulfone and monohalotriazine groups are preferred. Examples of suitable monohatotriazine groups are monochlorotriazine and monofluorotriazine. Most preferably the dye molecule will contain at least two different types of reactive groups, e.g. both vinyl sulfone groups and monohalotriazine groups. Such dyes often are called “bifunctional reactive dyes”.

After dyeing, the garments are ready for distribution to members of the public, accompanied by the visually readable imprint that (a) informs a reader that the garment has been colored with a formulation that contained at least a portion of the place or object and (b) identifies the nature of the portion that was used.

Preferably, there is placed on the exterior of the garment a visible representation of the place or object from whence came the particulate matter used in the dye slurry. This can be in words or a picture, or both. Preferably, the representation will be in the form of an imprint or embroidery. Methods of imprinting and embroidering garments that are well known in the art can be used to place such a representation on the garment. Thus, for example, screen printing or machine embroidering can be used. If the garment is only to be partially dyed with the memento-containing mixture, this step of placing on it a visible representation of the object involved can also serve as the dyeing step. Thus, for example, a quantity of white t-shirts can each be screen printed with a picture of the place or object, using a dye mixture formulated with, for example, soil removed from the place or paint that has been scraped off the surface of the object.

The visible representation of the place or object can be located any place on the exterior of the garment. If it is a shirt, it might be located on the back or front, e.g., at the left breast location or just below the neck band on the back. If the shirt has sleeves, the visible representation might be located on one or both of the sleeves, e.g., on the outer surface of the sleeve, near the top of the arm hole.

Also, it may be desirable to imprint or embroider on the garment certain event information, e.g., an identification of an historic event that occurred at the place, or a spectator event in which the object has been used. Thus, for example, if the garment commemorates a stock car or driver that has won a particular race, text identifying that race might be imprinted or embroidered on the garment. Similarly, if the car was driven by someone who was declared the driver of the year by a race sanctioning body, text so indicating might be imprinted or embroidered on the garment.

Also, it may be desirable to imprint or embroider on the garment certain date information. Thus, for example, if the garment commemorates a stadium or arena that has been, or is being, torn down, the years during which the building was in existence, e.g., “1929-2000,” might be imprinted or embroidered on the garment.

Also, there may be imprinted or embroidered on the garment the name of an entity that is sponsoring the commemoration effort.

Also, there may be imprinted or embroidered on the garment the name of a charitable organization that will benefit financially from sales of the garment.

As mentioned, a visually readable imprint that informs the reader that the garment has been colored in a formulation containing at least a portion of the place or object involved is to accompany the garment when it is distributed to a member of the public, e.g., sold to a fan. Also, the imprint should identify the nature of the portion that was used, e.g., whether it was brick from the building, wood from the court, grass from the field, paint from the race car, leather from the football, wood from the baseball bat, or whatever. For instance, the imprint can read: “Dyed with the dirt and grass of Memorial Stadium” or “Dyed with paint from Reggie Price's Ford Taurus, winner of the 1999 Springfield 500.” The imprint can be attached to the garment, e.g., as a hang tag, or it can be enclosed with the garment, inside a container, e.g., a mailing carton or envelope, or a plastic bag.

The imprint can itself contain all of the information about the material that has been used to color the garment, as well as the place or object from whence it came, or the imprint can refer the reader to a representation on the garment itself for some of that information, e.g., the specific identity of the place or object from whence the material came. Thus, for example, the imprint might read, “The dye used to color this shirt contains paint taken from the legendary car this shirt memorializes,” and there can be printed or embroidered on the shirt itself a representation of that car, e.g., the words “Reggie Price's Ford Taurus, No. 18,” alone or together with an image of the car.

Alternatively, for example, the imprint might read, “The dye used in the coloring of this shirt contains dirt and grass taken from the hallowed grounds of the legendary site this shirt symbolizes,” and there can be printed or embroidered on the shirt itself a representation of that place, e.g., the words “Notre Dame Football” (alone or together with an image of the Notre Dame football stadium) or the words “Gettysburg National Military Park” (alone or together with an image of the memorial statue located in the park).

Embodiments of the invention will now be described by way of example only with reference to the drawings.

Accompanying this specification are two sheets of drawings, which present five Figures.

FIG. 1 depicts a t-shirt prepared by immersion dyeing according to the method of the present invention;

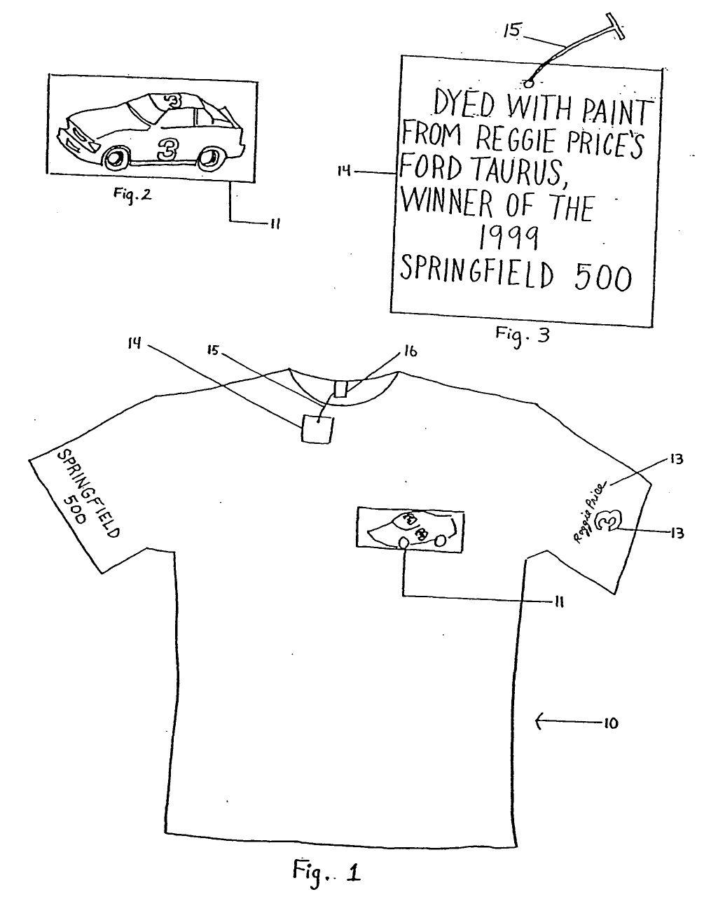

FIG. 2 is an enlarged view of the embroidered design on the breast of the t-shirt of FIG. 1;

FIG. 3 is an enlarged view of the hang tag attached to the t-shirt of FIG. 1;

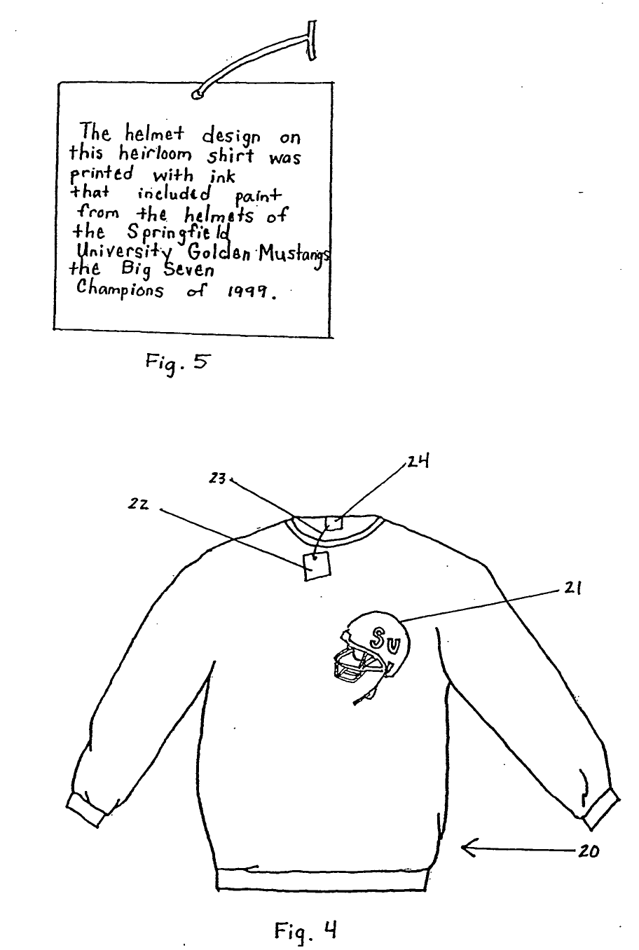

FIG. 4 depicts a sweatshirt prepared by screen printing a design according to the method of the present invention; and

FIG. 5 is an enlarged view of the hang tag attached to the sweatshirt of FIG. 4.

The method of the present invention will perhaps be better understood by considering the following examples, which are offered for illustration purposes.

### EXAMPLE 1

Into a 400 gallon capacity Cascadex dyeing machine (manufactured by American Laundry Machinery, Cincinnati, Ohio) was added, in the following order, 240 gallons of tap water, six pounds of a dye mixture, 150 pounds of salt, three pounds of soda ash, and two-and-a-half pounds of a particulate mixture of dirt and grass from the playing field of Memorial Stadium, in Baltimore, Md. The Cascadex dyer is a rotary style machine, in which the tub rotates around a horizontal axis. The dye mixture used was a mixture of Synnallon reactive dyes—namely, primary blue, primary green, and primary yellow, in a weight ratio of 0.56 parts blue, 0.36 parts green, and 0.825 parts yellow. The resulting color was a hue that often is called hunter green.

The dye slurry was heated, with agitation, to approximately 200° F. Then 300 pounds of undyed (white), 100% cotton t-shirts (approximately 40 dozen), were loaded into the machine. The shirts were Fruit of the Loom® PFD Tee brand shirts, made of approximately six ounce weight knit fabric. Each shirt had a care-and-content label sewn in the inside back of the neck seam.

The amount of dye that was used amounted to two percent, based on the dry weight of the t-shirts. The amount of salt (sodium chloride) used amounted to 50 grams per liter of water. The amount of soda ash used amounted to 5 grams per liter of water. The volume of water amounted to 9 parts for each part by weight of the shirts. Reactive dyes typically are used with cotton fabrics. The presence of the salt tends to drive the dye out of solution and onto the fabric. The soda ash raises the pH of the solution, causing the dye to fix. When using this type of dye and fabric, the particulate matter can be added at any time, but preferably it is added after the dye solution has reached dyeing temperature, e.g., approximately 200° F.

After agitation in the hot dye slurry for approximately one hour, the dye solution was drained out of the tub. Then the shirts were rinsed three times in cold tap water, which served to remove the salt and soda ash, as well as some, but not all, of the soil. Some reflective quartz particles from the soil could be seen in the fabric of the wet t-shirts. The shirts were removed from the dyeing machine, placed in a commercial dryer, and dried at 150° F. for approximately 30 minutes.

After removal from the dryer, each of the shirts was embroidered on the front, at the left breast, with both the words “Memorial Stadium” and an aerial view image of the stadium from whence the dirt and grass used in the dyeing operation had been removed. The outer surface of the right sleeve was embroidered with the names of two sponsors of the project, as follows: “1^{st} MARINER BANK” and, below that, “Radio11 WBAL.” To the outer surface of the left sleeve was added embroidered copies of the signatures of two famous ballplayers who had played for many years at Memorial Stadium—namely, Brooks Robinson and Johnny Unitas.

A hang tag was then attached by a breakable plastic anchoring filament to the care-and-content label of each of the shirts. The tag read as follows: “IMPORTANT! PLEASE READ. Hallowed Ground Series. This is an original, authentic, notarized product of the Hallowed Ground Series. The dye used in the coloring of the shirt contains dirt and grass taken from the hallowed grounds of the legendary site this shirt symbolizes. Tag of Authenticity.”

Finally, the shirts were distributed to members of the public, each with the hang tag in place.

### EXAMPLE 2

Into a 400 gallon capacity Cascadex dyeing machine (manufactured by American Laundry Machinery, Cincinnati, Ohio) is added, in the following order, 240 gallons of tap water, six pounds of a dye mixture, 150 pounds of salt, three pounds of soda ash, and two pounds of paint scrapings from a 1998 Ford Taurus that has won the 1999 Springfield 500 stock car race, driven by Reggie Price. (The names and event are fictional.) The Cascadex dyer is a rotary style machine, in which the tub rotates around a horizontal axis. The dye mixture used is a mixture of Synnallon reactive dyes—namely, primary blue, primary green, and primary yellow, in a weight ratio of 0.56 parts blue, 0.36 parts green, and 0.825 parts yellow. The resulting color is a hue that often is called hunter green, and it is approximately the same as the color of the paint scrapings used.

The dye slurry is heated, with agitation, to approximately 200° F. Then 300 pounds of undyed (white), 100% cotton t-shirts (approximately 40 dozen), are loaded into the machine. The shirts are Fruit of the Loom® PFD Tee brand shirts, made of approximately six-ounce weight knit fabric. Each shirt has a care-and-content label sewn in the inside back of the neck seam.

The amount of dye that is used amounts to approximately four percent, based on the dry weight of the t-shirts. The amount of salt (sodium chloride) used amounts to 50 grams per liter of water. The amount of soda ash used amounts to 5 grams per liter of water. The volume of water amounts to 9 parts for each part by weight of the shirts. Reactive dyes typically are used with cotton fabrics. The presence of the salt tends to drive the dye out of solution and onto the fabric. The soda ash raises the pH of the solution, causing the dye to fix. When using this type of dye and fabric, the particulate matter can be added at any time, but preferably it is added after the dye solution has reached dyeing temperature, e.g., approximately 200° F.

After agitation in the hot dye slurry for approximately one hour, the dye solution is drained out of the tub. Then the shirts are rinsed three times in cold tap water, which serves to remove the salt and soda ash, as well as some, but not all, of the paint scrapings. The shirts are removed from the dyeing machine, placed in a commercial dryer, and dried at 150° F. for approximately 30 minutes.

After removal from the dryer, each of the shirts 10 is embroidered on the front, at the left breast, with a multicolor drawing 11 of the car from which the paint scrapings were taken. The outer surface of the right sleeve is embroidered in yellow thread 12 with the legend “Springfield 500”. Onto the outer surface of the left sleeve is embroidered a copy of the signature 13 of the winning driver of the car, the fictional Reggie Price, together with the number of the car, also using yellow colored thread.

A hang tag 14 is then attached by a breakable plastic anchoring filament 15 to the care-and-content label 16 of each of the shirts. The tag reads as follows: “Dyed with paint from Reggie Price's Ford Taurus, winner of the 1999 Springfield 500”.

Finally, the shirts are distributed to members of the public, each with the hang tag in place.

### EXAMPLE 3

Five ounces of gold paint is scraped off the helmets of Springfield University's football team (a fictional school). The paint scrapings are pulverized using a mortar and pestle and then thoroughly mixed into ten pounds of a textile ink that is suitable for screen printing, and which is within about five shades, on the Pantone color chart, of the color of the gold paint. The openings in the screen are wide enough so as not to screen out all of the pulverized paint particles, as the textile ink is squeegeed through the screen, onto the fabric.

The ink mixture is then used to screen print onto the fronts of new, grey, 100% cotton sweatshirts 20 a side view drawing 21 of one of the Springfield University helmets. To complete the picture, each shirt 20 is overprinted: first in red, to add the letters “SU” to the picture of the helmet, then in black, to outline the helmet and to show a mouthguard and chin strap. The ink is then dried by running the t-shirt through a conveyor oven maintained at a temperature of approximately 300° F. Particles of the souvenir helmet paint that have passed through the screen are thereby held to the fabric, embedded in the cured ink.

On heavy paper stock is printed three-inch-square hang tags 22 bearing the message, “The helmet design on this heirloom shirt was printed with ink that included paint from the helmets of the Springfield University Golden Mustangs, the Big Seven Champions of 1999”.

Each sweatshirt, as acquired, has a care label 24 sewn into the inside neckband.

After the screen printing, one of the hang tags 22 is attached to each care label by a breakable plastic filament 23, of the type used by retail stores to attach price tags to ready-to-wear garments. Then the t-shirts are distributed, with the hang tags attached, to members of the public.

Although specific embodiments of the present invention have been described above in detail, it will be understood that this description is merely for purposes of illustration. Various modifications or equivalent structures corresponding to the disclosed aspects of the preferred embodiments, in addition to those described above, may be made by those skilled in the art, without departing from the present invention, which is defined by the following claims.

1. A method of manufacturing and distributing a garment that commemorates a tangible object that has served as an instrument in the performance of a spectator event, comprising the following steps:
a) converting at least a portion of the object to a particulate form,
b) mixing said particulate matter with a dye composition to form a dye mixture,
c) obtaining a quantity of dyeable garments,
d) dyeing at least a portion of each of said garments, using said dye mixture, and
e) distributing said dyed garments to members of the public, each one accompanied by a visually readable imprint.

2. The method of claim 1, wherein there is placed on the exterior of the garment a visible representation of the object from whence came the particulate matter used in the dye mixture.

3. The method of any preceding claim, wherein, in step (d), only a portion of each of said garments is dyed using said dye mixture, and said dyeing is done by screen printing.

4. The method of any preceding claim, wherein the object comprises a painted race car and, in step (a), at least some of said paint is converted to particulate form.

5. The method of any preceding claim, wherein the dye in the dye composition is at least approximately the same color as said paint.

6. The method of any preceding claim, wherein the garments are t-shirts.

7. The method of claim 6, wherein the race car is a stock car.

8. The method of claim 7, wherein the stock car is one that has been declared the winner of an officially sanctioned stock car race, prior to removal of said paint.

9. The method of any of claims 1, 2, and 4 through 8, wherein steps c) and d) comprise:
i) immersing a quantity of undyed, dyeable garments in said dye slurry,
ii) agitating said garments in said dye slurry so as to color them,
iii) removing said garments from the dye slurry and rinsing them with water, and
iv) drying said rinsed garments.

10. A method of manufacturing and distributing a garment that commemorates a place of public accommodation that comprises either a building that has served as a gathering place for people or a playing surface on which spectator events have been presented, or both, comprising the following steps:
a) removing a portion of the building or playing surface,
b) converting said removed portion to a particulate form,
c) mixing said particulate matter with a dye solution to form a dye slurry,
d) immersing a quantity of undyed, dyeable garments in said dye slurry,
e) agitating said garments in said dye slurry so as to color them,
f) removing said garments from the dye slurry and rinsing them with water,
g) drying said rinsed garments, and
h) distributing said dried garments to members of the public, each one accompanied by a visually readable imprint.

11. The method of claim 10, wherein after said step g) there is placed on the exterior of the garment a visible representation of the place from whence came the particulate matter used in the dye slurry.

12. The method of claim 11, wherein the place comprises a grassy playing surface and the removed portion comprises some of said grass.

13. The method of any of claims 10 to 12, wherein the dye in the dye solution is green in color, thereby rendering the dried garments green.

14. The method of claims 12 or 13, wherein the grassy playing surface is a field on which sporting events have been played for public exhibition.

15. The method of claim 14, wherein the field is a baseball field or a football field or both, and the removed portion comprises grass and soil from said field.

16. The method of claim 11, wherein the place comprises a wooden playing surface and the removed portion comprises some of said wood.

17. The method of claim 16 wherein, in step b, the wood is converted into particles that are sufficiently small in size that, in step e, they do not tear or visibly abrade the garments.

18. The method of claim 17, wherein the wooden playing surface is a basketball court.

19. The method of claim 18, wherein the dye in the dye solution is brown in color, thereby rendering the dried garments brown.

20. The method of claim 19, wherein the place comprises an automobile race track and the removed portion comprises part of the track surface.

21. The method of claim 20, wherein the removed portion comprises tire rubber scraped off the track surface.

22. The method of claim 21, wherein the dye in the dye solution is black in color, thereby rendering the dried garments black.

23. The method of claim 22, wherein the place comprises a brick building that has served as an athletic stadium and the removed portion comprises part of the brick.

24. The method of claim 23, wherein, in step b, the brick is converted into particles that are sufficiently small in size that, in step e, they do not tear or visibly abrade the garments.

25. The method of claim 24, wherein the dye in the dye solution is approximately the same color as the removed brick.

26. The method of any of claims 11 to 25, wherein the garments are t-shirts.

27. A method of manufacturing and distributing a garment that commemorates a place or tangible object, comprising the following steps:
a) converting at least a portion of the place or object to a particulate form,
b) mixing said particulate matter with a dye composition to form a dye mixture,
c) obtaining a quantity of dyeable garments,
d) dyeing at least a portion of each of said garments, using said dye mixture, and
e) distributing said dyed garments to members of the public, each one accompanied by a visually readable imprint.

28. The method of claim 27, wherein there is placed on the exterior of the garment a visible representation of the place or object from whence came the particulate matter used in the dye mixture.

29. The method of either claim 27 or claim 28, wherein the garment commemorates an historic event or a memorial park or cemetery, and a portion of that place that is converted to particulate form is grass, soil, or a mixture of grass and soil from that place.

30. The method of any of claims 27 through 29, wherein the garments are t-shirts.

31. The method of any of claims 27-30, wherein, after said step d, there is placed on the exterior of the garment a visible representation of the place from whence came the particulate matter used in the dye slurry.

32. The method of any of claims 27-31, wherein the garments are t-shirts.

33. The method of any of claims 27-32, wherein, in step d, only a portion of each of said garments is dyed using said dye mixture, and said dyeing is done by screen printing.

34. The method of any of claims 27-32, wherein said step d is performed by:
i) immersing a quantity of undyed, dyeable garments in said dye slurry,
ii) agitating said garments in said dye slurry so as to color them,
iii) removing said garments from the dye slurry and rinsing them with water, and
(iv) drying said rinsed garments.

35. The method of any preceding claim wherein the dye has a lightfastness classification of at least L4 on the Xenon Arc 20 Hour Colorfastness to Light Test Method 16-1998.

36. The method of claim 35 wherein the lightfastness classification is in the region of L4 to L5.

37. The method of any preceding claim wherein the dye has a colorfastness classification of at least Grade 4 in respect of the AATCC Colorfastness to Perspiration Test Method 15-1997.

38. The method of claim 37 wherein the colorfastness classification is in the region of Grade 4 to Grade 5.

39. The method of any preceding claim wherein the dye is a reactive dye.

40. The method of any preceding claim wherein the dye molecule has one or more reactive vinyl sulfone or monohalotriazine groups.

41. The method of claim 40 wherein the monohalotrazine group is monochlorotriazine or monofluorotriazine.

42. The method of any preceding claim wherein the dye has at least two different reactive groups on the same molecule

43. The method of any preceding claim wherein the dye is a difunctional reactive dye.

44. The method of any preceding claim in which the visually readable imprint used in step e informs the reader that the garment has been colored in a formulation containing a portion of said place or object and that identifies the nature of the portion that was used.

45. The method of any preceding claim wherein the dye molecule has at least one reactive vinyl sulfone group and at least one reactive monohalotriazine group.

46. A garment produced according to any preceding claim.

47. A garment wherein at least a portion thereof has been dyed with a dye mixture comprising particulate matter and a dye composition.
